(19) United States
(12) Patent Application Publication
(10) Pub. No.: US 2004/0174962 A1
(43) Pub. Date: Sep. 9, 2004

(54) Alarm clock telephone

(76) Inventor: Matthew Dubreuil, Denham Springs, LA (US)

Correspondence Address: Matthew Dubreuil, 32735 Faulkner Drive, Denham Springs, LA, 70706, US

(21) Appl. No.: 10/435,632

(22) Filed: May 12, 2003

Related U.S. Application Data
(60) Provisional application No. 60/451,755, filed on Mar. 4, 2003.

(51) Int. Cl. H04M 1/64

(52) U.S. Cl. 379/67.1

(57) ABSTRACT

The new art to which the invention pertains is new alarm clock technology.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### BACKGROUND OF THE INVENTION

“Field of Invention”

The back ground of the invention is while cleaning my desk I put my alarm clock on my telephone and said “Look an ALARM CLOCK TELEPHONE”. Thus I decided that the union of these two technologies would be beneficial. By using pre-existing telephone and alarm clock, the invention should be creatable.

### BRIEF SUMMARY OF THE INVENTION

This is a device that would combine a regular telephone with an alarm clock. Its main feature would be that the phone will ring when the alarm is set. The device will then play back a pre recorded message. Another feature would be that the keypad would set the time and alarm. The device can be set to ring (that is as an incoming phone call) at a preset time. When the phone is answered the pre taped message will play. This allows a wake up call or memorandum to be received as a “normal phone call”. The traditional features would include snooze. There will be a raised display to tell the time. Indicators of alarm set and am/pm will also be displayed.

### BRIEF DESCRIPTION OF THE SEVERAL VIEWS OF THE DRAWING

“Not Applicable”

### DETAILED DESCRIPTION OF THE INVENTION

Taking a standard alarm clock and a standard digital voice incoming out going message telephone and uniting the two setting forth a new invention. This invention will record a message and set an alarm. Then, it sounds as if an incoming phone call has come in. A person answers the phone and hears the pre-taped message.

1. What I claim as my invention is the uniting of an alarm clock and a telephone. It will pre-tape a message. It will have an alarm set. It will ring as if it had an incoming call. Once it is answered the pre-taped message will play.
